(19) United States
(12) Patent Application Publication
(10) Pub. No.: US 2013/0238391 A1
(43) Pub. Date: Sep. 12, 2013

(54) PRODUCT ORIENTED WEB SITE ANALYTICS

(71) Applicants: Jeffrey Thomas KLUMPP, Atlanta, GA (US); John Thomas LYNCH, II, Bradenton, FL (US); Jonathan GRIMM, Niantic, CT (US); Vladimir ZELEVINSKY, Sharon, MA (US); Benjamin TRAFTON, Boston, MA (US)

(72) Inventors: Jeffrey Thomas KLUMPP, Atlanta, GA (US); John Thomas LYNCH, II, Bradenton, FL (US); Jonathan GRIMM, Niantic, CT (US); Vladimir ZELEVINSKY, Sharon, MA (US); Benjamin TRAFTON, Boston, MA (US)

(73) Assignee: ORACLE INTERNATIONAL CORPORATION, Redwood Shores, CA (US)

(21) Appl. No.: 13/469,761

(22) Filed: May 11, 2012

Related U.S. Application Data
(60) Provisional application No. 61/608,826, filed on Mar. 9, 2012.

(51) Int. Cl. G06Q 30/02

(52) U.S. Cl. 705/7.29

(57) ABSTRACT

A system for generating web page analytics generates a plurality of web pages that each include a plurality of products and a plurality of web page sections, and each product is displayed in at least one of the sections of the web page. The system receives a plurality of selections by a user of one or more of the products and, for each selection, logs data that includes a selected product and a section of the web page where the selected product was displayed when it was selected by the user. The system then generates web page analytics from the logged data, where the analytics are based at least on the selected product and the corresponding section of the web page where the selected product was displayed.

### CROSS REFERENCE TO RELATED APPLICATIONS

This application claims priority of Provisional Application Ser. No. 61/608,826, filed on Mar. 9, 2012, the content of which is hereby incorporated by reference.

### FIELD

One embodiment is directed generally to a computer system, and in particular to a computer system that generates web site analytics.

### BACKGROUND INFORMATION

Web site or web page analytics is the measurement, collection, analysis and reporting of Internet data for purposes of understanding and optimizing web usage. Web site analytics can be used as a tool for business research and market research, and to assess and improve the effectiveness of a web site. Web analytics applications can also help companies measure the results of traditional print advertising campaigns or help a company to estimate how traffic to a web site changes after the launch of a new advertising campaign. Web site analytics provide information about the number of visitors to a web site and the number of page views. It helps gauge traffic and popularity trends

For electronic commerce (“e-commerce”) applications, web site analytics measure a visitor's journey once on an e-commerce web site, such as which landing pages encourage people to make a purchase. This data is typically compared against key performance indicators for performance, and is used to improve a web site or analyze the audience response to a marketing campaign.

### SUMMARY

One embodiment is a system for generating web page analytics. The system generates a plurality of web pages that each include a plurality of products and a plurality of web page sections, and each product is displayed in at least one of the sections of the web page. The system receives a plurality of selections by a user of one or more of the products and, for each selection, logs data that includes a selected product and a section of the web page where the selected product was displayed when it was selected by the user. The system then generates web page analytics from the logged data, where the analytics are based at least on the selected product and the corresponding section of the web page where the selected product was displayed.

### BRIEF DESCRIPTION OF THE DRAWINGS

FIG. 1 is a block diagram of a computer server/system in accordance with an embodiment of the present invention.

FIG. 2 is a screen shot of an annotated e-commerce web page of a web site generated by the system and displayed on a client computer in accordance with an embodiment of the present invention.

FIG. 3 is an overview block diagram of the product oriented web site analytics system in accordance with one embodiment.

FIG. 4 is a flow diagram of the functionality of the product oriented web site analytics module of FIG. 1 when generating web site analytics based on the products displayed on a web site in accordance with one embodiment.

### DETAILED DESCRIPTION

One embodiment is a system that generates web site analytics based on the products displayed on the web site, including metrics based on individual product performances, products by category/attribute performance, and the position of each product on the web site. The generated web analytics provides product specific intelligence, as opposed to general web site intelligence. Therefore, e-commerce results are tracked in terms of product impressions rather than generic web site impressions.

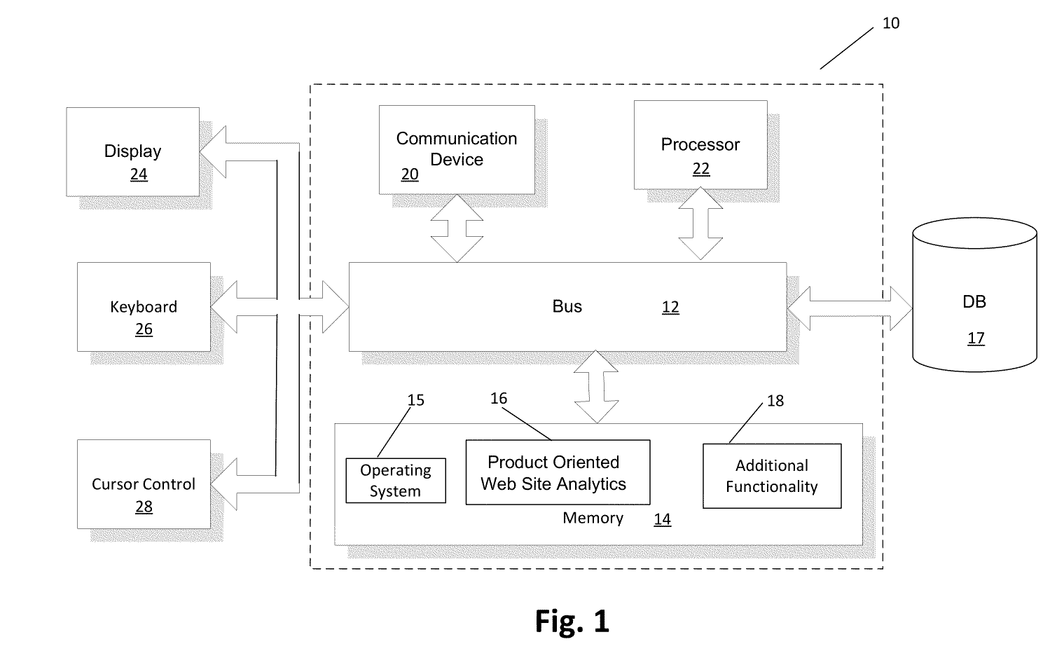

FIG. 1 is a block diagram of a computer server/system 10 in accordance with an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include product oriented web site analytics module 16 that generates product oriented analytics, as disclosed in more detail below. System 10 can be part of a larger system, such as a web based e-commerce retail system, a business intelligence (“BI”) system, or an enterprise resource planning (“ERP”) system. Therefore, system 10 will typically include one or more additional functional modules 18 to include the additional functionality. A database 17 is coupled to bus 12 to provide centralized storage for modules 16 and 18 and store inventory information, product information, ERP data, etc.

In one embodiment, system 10 is a web server or is coupled to a web server that is accessed by a user over the Internet. The use can access system 10 via any type of device that can interface with server 10 over a network, including a laptop computer, smart phone, tablet, etc., using a wired or wireless connection, or any other method. One type of user is a user who interacts with web sites generated by server 10 in, for example, an e-commerce environment. Another type of user receives product oriented web site analytics that is based on the e-commerce user interactions.

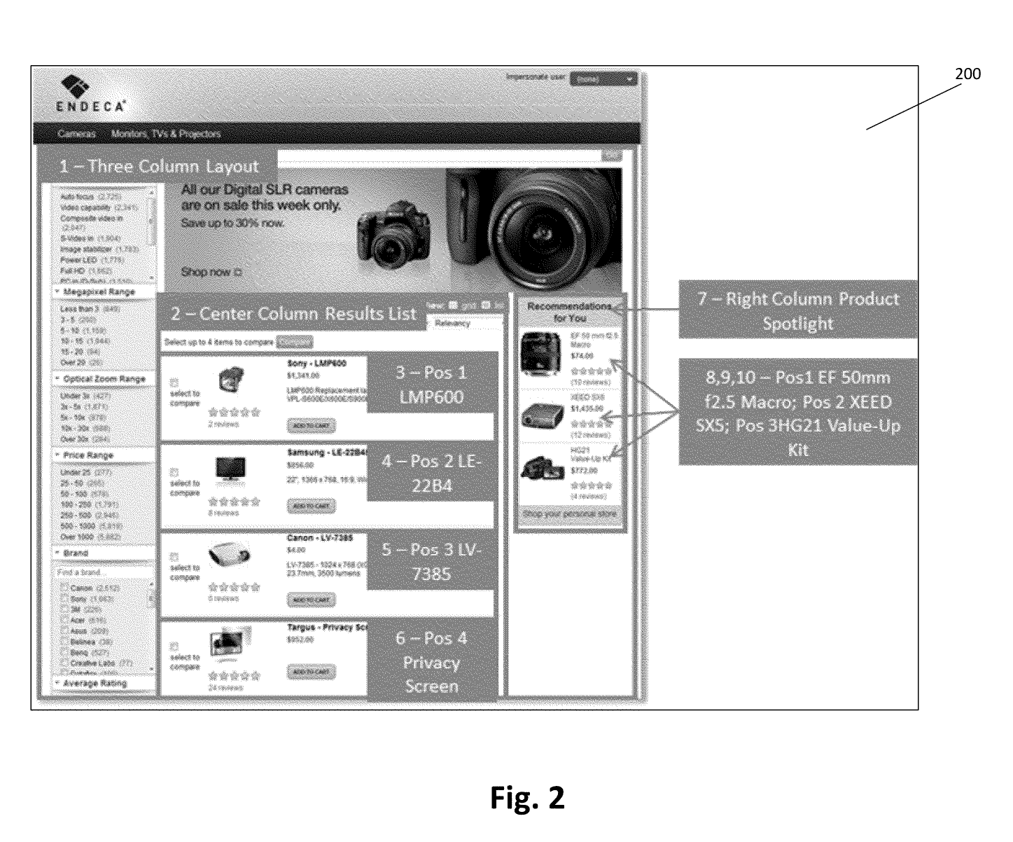

FIG. 2 is a screen shot of an annotated e-commerce web page 200 of a web site generated by system 10 and displayed on a client computer in accordance with an embodiment of the present invention. Web page 200 is part of an e-commerce web site selling digital cameras on the page shown in FIG. 2, as well as other cameras, monitors, televisions and projectors on other web pages.

Known approaches for tracking the efficacy of e-commerce web sites, such as the web site of FIG. 2, focus on page tracking. For example, prior art metrics are focused on the web page itself, such as total pages views, the referral page, page conversions, page conversion rate, page bounces, page bounce rate, etc., rather than the products comprising the page.

In contrast, embodiments of the present invention analyze web sites as a series of product impressions rather than page views. Therefore, in one embodiment, rather than view page 200 as a single unit to be tracked and measured, page 200 instead is broken down into a collection of products shown and the location on the web page where each product is shown to the customer. The location of a product on a web page, also referred to as the section of the page, or the page “cartridge”, is analogous to the shelf space position in a “real world” retail store. It is known that the position of a product on a real world shelf (e.g., Is the product at eye level? Is the product at the beginning of the shelf or in the middle?) can affect the sales of the product.

Web page 200 has been annotated to show ten distinct measurable artifacts including product, placements and layouts that can be used by embodiments of the present invention to provide intelligence/metrics for the e-commerce web site. These artifacts include: (1) the three column layout; (2) the center column results list; (3-6) the four different positions of the center column; (7) the right column product spotlight; and (8-10) the three different positions of the right column.

In one embodiment, using the artifacts described above, four major areas of data acquisition are obtained:
Application logging;
Web client-side logging;
Data aggregation; and
Product data acquisition.

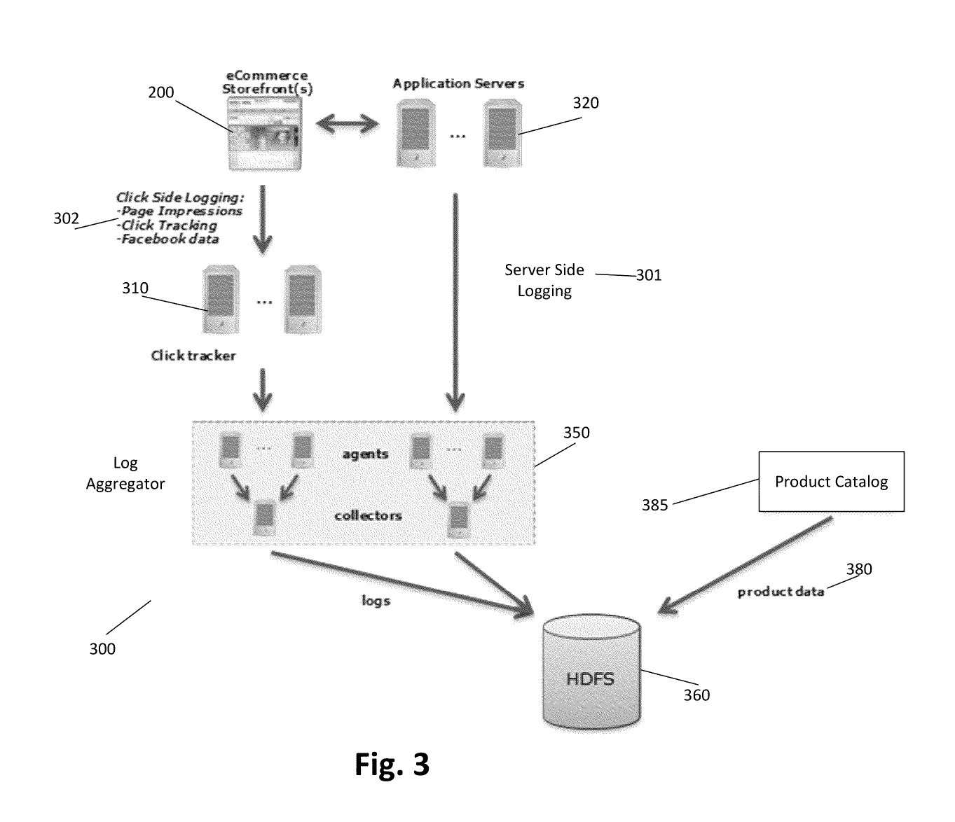

FIG. 3 is an overview block diagram of the product oriented web site analytics system 300 in accordance with one embodiment. FIG. 3 illustrates how the above-described data is collected and flows through the system. System 300 includes one or more client servers 310 for logging client side data, one or more application servers 320 for logging web/application server data, and one or more aggregator servers 350 for aggregating the client side data and application side data. Servers 310, 320 and 350 may be implemented by system 10 of FIG. 1, and a single server may implement the functionality of multiple servers. For example, the same server can perform the client side logging, application side logging, and aggregation.

Application servers 320 log detailed information about each request from a user interacting with an e-commerce web page. The server side logged data primarily includes the page content, page context, and request metadata. The page content (“Content”) is logged in one embodiment as a nested JavaScript Object Notation (“JSON”) structure similar to the content items it is representing but with varying levels of detail per cartridge/web page section as desired. The page context (“Navigation”) contains the user's current navigation state. The request metadata (other top-level properties) contains a random selection of useful information such as the time of the request, the actual uniform resource locator (“URL”) requested, as well as a unique ServerRequestId that can be used to tie together these application logs with the client-side logs.

The following pseudo-code provides the JSON that is logged by the application logger in accordance with one embodiment:

```
{
      ″PageName″:″Default Experience″,
      ″ServerRequestId″:″afbd6cf1-3994-4f89-8382-fec4ee1fc124″,
      ″RequestUrl″:″/discovervino/browse?N=8103&No=10&Nrpp-10&Ns=P_
Price%7C0&Ntt=cabernet″,
      ″Navigation″:{
            ″PageNumber″:″2″,
            ″Searches″:[
              {
                  ″SearchMode″:″allpartial″,
                  ″SearchTerm.″:″cabernet″,
                  ″SearchKey″:″All″
              }
            ],
            ″ResultsCount″:″4622″,
            ″ResultsSort″:″Price (Ascending)″,
            ″SelectedDimensicnValues″:[
              ″/Wine Type/Red/Cabernet Sauvignon″
            ]
      },
      ″Content″:[
            ″Cartridges″:[
              {
                  ″Name″:″header″,
                  ″Cartridges″:[
                    {
                      ″Name″:″Search Box Slot″,
                      ″Cartridges″:[
                        {
                          ″Name″:″contents″,
                          ″Cartridges″:[
                            {
                              ″Name″:″Default Search Box″,
                              ″Created″:″1321631740685″,
                              ″ContentUri″:″/content/SearchBox/D
efault″,
                              ″CreatedBy″:″admin″
                              ″autoSuggestBaseAction″:″/autosugg
est.json″
                              ″searchBaseAction″:″/browse″,
                              ″LastModifiedBy″:″admin″,
                              ″LastModified″:″1321886023535″,
                              ″minAutoSuggestInputLength″:″1″,
                              ″autoSuggestEnabled″:″true″,
                              ″ContentPosition″:″1″,
                              ″TemplateId″:″SearchBoxItem″
                            }
                          ],
                          ″ContentPosition″:″1″,
                          ″TemplateId″:″ContentSlot″
                        }
                      ],
                      ″ruleLimit″:″1″,
                      ″contentCollection″:″SearchBox″,
                      ″ContentPosition″:″1″,
                      ″TemplateId″:″SearchBoxSlot″
                    }
                  ],
                  ″ContentPosition″:″1″,
                  ″TemplateId″:″ContentSlot″
              },
              {
                  ″Name″:″leftColumn″,
                  ″Cartridges″:[
                  ],
                  ″ContentPosition″:″1″,
                  ″TemplateId″:″ContentSlot″
              },
              {
                  ″Name″:″main″,
                  ″Cartridges″:[
                    {
                      ″Name″:″ATG Promotion″,
                      ″title″:″Wine Friday Free Shipping!″,
                      ″location″:″_banner″,
                      ″promotion″:″freeshipping″,
                      ″heading″:″h3″,
                      ″ContentPosition″:″1″,
                      ″TemplateId″:″ATGPromotion″
                    },
                    {
                      ″Name″:″Search Adjustments″
                      ″originalTerms″:″cabernet″,
                      ″ContentPosition″:″2″,
                      ″TemplateId″:″SearchAdjustments″
                    },
                    {
                      ″PageResultsCount″:10,
                      ″Name″:″Default Search Results List″,
                      ″Records″:[
                        ″2804″,
                        ″4013″,
                        ″25252″,
                        ″7589″,
                        ″7652″,
                        ″7584″,
                        ″4001″,
                        ″4011″,
                        ″5241″,
                        ″1585″
                      ],
                      ″Created″:″1321637162813″
                      ″ContentUri″:″/content/SearchResultsList/Defau
lt″,
                      ″CreatedBy″:″admin″,
                      ″LastModifiedBy″:″admin″,
                      ″LastModified″:″1321886187173″,
                      ″ContentPosition″:″3″,
                      ″TemplateId″:″ResultsListItem″,
                    }
                  ],
                  ″ContentPosition″:″1″,
                  ″TemplateId″:″ContentSlot″,
              },
              {
                  ″Name″:″rightColumn″,
                  ″Cartridges″:[
                    {
                      ″Name″:″Featured Wines″,
                      ″Records″:[
                        ″7750″,
                        ″13389″,
                        ″20691″,
                      ],
                      ″Created″:″1321631346596″,
                      ″ContentUri″:″/content/RecordSpotlightContent/
Browse by Winery or Wine Type″,
                      ″CreatedBy″:″admin″,
                      ″LastModifiedBy″:″admin″,
                      ″LastModified″:″1321641447912″,
                      ″ContentPosition″:″1″,
                      ″TemplateId″:″RecordSpotlightItem″
                    }
                  ],
                  ″ContentPosition″:″1″,
                  ″TemplateId″:″ContentSlot″
              }
            ],
            ″ContentUri″:″/content/SearchAndNavigationPages/Default″,
            ″metaKeywords″:″wine spirits cheese″,
            ″metaDescription″:″Endeca eBusiness reference application.
″,
            ″links″:″[ ]″,
            ″LastModifiedBy″:″admin″,
            ″TemplateId″:″ThreeColumnNavigationPage″,
            ″Name″:″Default Experience″,
            ″title″:″Discover Vino!″,
            ″Created″:″1318915626617″,
            ″CreatedBy″:″admin″,
            ″LastModified″:″1321894342928″,
            ″ContentPosition″:″1″
      },
      ″TimeMillis″:1322512301256
}
```

In one embodiment, the client-side logger 310 is a javascript library that captures information from a user's browser, including page impressions, product clicks, and demographic information from logged-in users, such as users logging in via a related Facebook account. In one embodiment, the following pseudo-code provides tracker library javascript that can be included in any web page to be tracked:

<script type=″text/javascript″ src=″<c:url
value=″/js/EndecaClickTracker.js″/>″></script>

The tracker can then be initialized using the following pseudo-code:

```
  <script type=″text/javascript″>
        var userSystemId = '<%= MackUserService.getUserId(request)
%>';
          var requestContentId = '<%=
LoggingUtils.getRequestContentId(request)%>';
          var endecaTracker = EndecaTracker.getTracker({
                baseTrackUrl: 'http://10.17.56.252/',
                serverRequestId: requestContentId,
                userSystemId: userSystemId,
                productUrlRegex: 'ENDECA_CLASSIC',
                useFacebook: true,
                jQuery: $j
          });
          endecaTracker.initTracking( );
</script>
```

In one embodiment, two different types of data are logged by the client-side logger: page impressions and product clicks. Page impressions include one entry that is logged every time a user loads a page. The following is pseudo-code is an example page impression log entry:

```
{
      ″ServerRequestId″:″43ca8ccf-16ac-4bf7-88f6-01ce8ddb484a″,
      ″RequestUUID″:″8f556f24-2db9-4fcc-b522-aa383a8fa21a″,
      ″TimeMillis″:1318372679953,
      ″User″:{
            ″VisitorId″:″b5e2e03c-5a83-4aae-1894-fa9405bfd1ea″,
            ″ServerUserId″:″9fd8c192-a3df-4780-9675-7bc34c7e7fe2″
      },
      ″Session″:{
            ″SessionId″:″0228c494-1958-970a-895c-7165fd7b87fb″
      },
      ″facebook″:{
            ″sex″:″male″,
            ″birthday_date″:″03/27/1985″,
            ″city″:″Boston″,
            ″state″:″Massachusetts″
      },
      ″type″:″pageview″
}
```

The second type of data captured by the logger is product clicks. When a user clicks on one of the URLs, that click is logged in one embodiment. The following is pseudo-code of an example click log entry:

```
{
      ″ServerRequestId″:″43ca8ccf-16ac-4bf7-88f6-01ce8ddb484a″,
      ″RequestUUID″:″8f556f24-2db9-4fcc-b522-aa383a8fa21a″,
      ″TimeMillis″:1318372679953,
      ″User″:{
            ″VisitorId″:″b5e2e03c-5a83-4aae-1894-fa9405bfd1ea″,
            ″ServerUserId″:″9fd8c192-a3df-4780-9675-7bc34c7e7fe2″
      },
      ″Session″:{
            ″SessionId″:″0228c494-1958-970a-895c-7165fd7b87fb″
      },
      ″facebook″:{
            ″sex″:″male″,
            ″birthday_date″:″03/27/1985″,
            ″city″:″Boston″,
            ″state″:″Massachusetts″
      },
      ″record_id″:″22423″,
      ″context″:{
            ″path″:[
              ″Wine Type Page″,
              ″main″,
              ″Results List″
            ],
            ″position″:3,
            ″searches″:[
              {
                  ″SearchMode″:″allpartial″,
                  ″SearchTerm″:″merlot″,
                  ″SearchKey″:″All″
              }
            ],
            ″selectedDvals″:[
              ″/Wine Type/Red″
            ]
      },
      ″type″:″click″
}
```

While similar to the page impression entry, in one embodiment the product click data includes additional items. First, the identity (“ID”) of the clicked product is passed through in the “record_id” parameter. Second, some context around the click is passed through as well. For example, the cartridge/page section that contained the clicked record is included in the entry. This context information is actually embedded into the Hyper Text Markup Language (“HTML”) as the page is rendered by a modified include.tag in the web application. The modified tag wraps each cartridge in a div that has metadata in the data-cartridge attribute.

As the logger javascript will be terminated as soon as the page changes, the call to log a product click temporarily interrupts the normal page change in one embodiment. The log request is given up to 500 milliseconds to complete, then the user is sent on to the product page regardless of whether the log request has completed.

In one embodiment, the client side logger submits tracking information by requesting a single pixel image from a server with the tracking information contained in the URL. This approach avoids any cross domain issues. On the server side, in one embodiment, an Apache server is set up to receive the client-side logging requests. A custom handler using mod_perl accepts the requests, as shown in the following example pseudo-code:

```
PerlResponseHandler Apache::ClickLogger
PerlModule Apache::ClickLogger
    <Location />
            SetHandler modperl
            PerlResponseHandler Apache::ClickLogger
    </Location>
```

In one embodiment, the handler pulls out the log content from the query parameter and submits this content to a log-recording agent. After logging the message, a single pixel gif is returned to the browser.

System 300 consolidates the log data into a single location at aggregator servers 350. Log data comes from application servers 320 as well as click tracking servers 310. In one embodiment, a log aggregator is used to aggregate all these data streams. In one embodiment, the log aggregator is the Apache Flume System from the Apache Software Foundation (“Flume”).

In addition to the logged data, one embodiment correlates a standard product catalog 385 and product data 380 back to the logged data to enable reporting on metrics based on any attribute present in the catalog (e.g., color, brand, price, etc.). The logged data and product data 380 in one embodiment are stored in a Hadoop Distributed File System (“HDFS”) for later use by, for example, a business intelligence system.

One embodiment identifies the value of each and every piece of real-estate or electronic shelf space/cartridge/page section within the e-commerce web site. These values are then correlated to the total exposure each product gets within each of those page sections. From this data, expected and actual product performance can be determined to find which of the products are over/under performing based on units or revenue metrics. These metrics provide the e-commerce retailer with information to choose product/web page section placement, similar to a brick-and-mortar retail store choosing the products to display on an end cap (i.e., high value page section) versus a less desirable location.

The logged client and application data in one embodiment allows a user to identify: (a) Misplaced products as a result of bad data or misconfigured merchandising rules; (b) The “truly” most popular products based on a ratio of popularity to exposure, in order to prevent the problem of self-fulfilling popularity which is commonly witnessed when popular products are automatically given priority placement; (c) Brands, categories, etc., of products exhibiting increases or decreases in “true” popularity to help merchants identify and respond to emerging shopping trends.

Embodiments can generate the following example metrics in response to the client and application logged data:

Impression: The total count of times an element (such as products, pages, cartridges/page sections, etc.) has been displayed to a user.

Exposure Score: A numeric value identifying the total exposure that an element (typically a product) has received across the digital channels. A larger value indicates greater exposure. Exposure differs from an impression in that a weight is added to each impression indicating the value of that impression. For example, the “better” the page section in which the product is displayed, the higher the weighting for that impression. This is analogous to the case of a brick-and-mortar store, where an end cap impression would contribute a higher exposure score than an impression buried in the bottom middle of an aisle.

Opportunity Score: A numeric score identifying whether an item (typically a product or an aggregate of some product attribute such as category) is exceeding or missing expectations. Items with high opportunity scores are excellent candidates to be given greater exposure on the electronic shelves via search boosting or merchandising whereas items with low opportunity scores are wasting electronic shelf space and should therefore be removed from merchandising rules and where appropriate buried in search results. In one embodiment, the opportunity score is calculated as a ratio of the product selection rate to its exposure score.

Click: The total count of times an item (typically a product or cartridge) is physically clicked/selected by a user.

Click Rate: “Total Clicks”/“Total Impressions”.

Revenue Influence: Indicates the total amount of revenue influenced by this item (such as products, pages, cartridges, etc.) calculated as “Total Clicks” multiplied by “Clicked Item Price”.

Impression Value: The total revenue influence for each impression of this item (typically a page or cartridge).

Result Set Size: A search reporting metric indicating the total number of items (products) returned for a specific query. Common search keywords/phrases with very few results (less than 10) should be investigated to ensure they are tuned correctly.

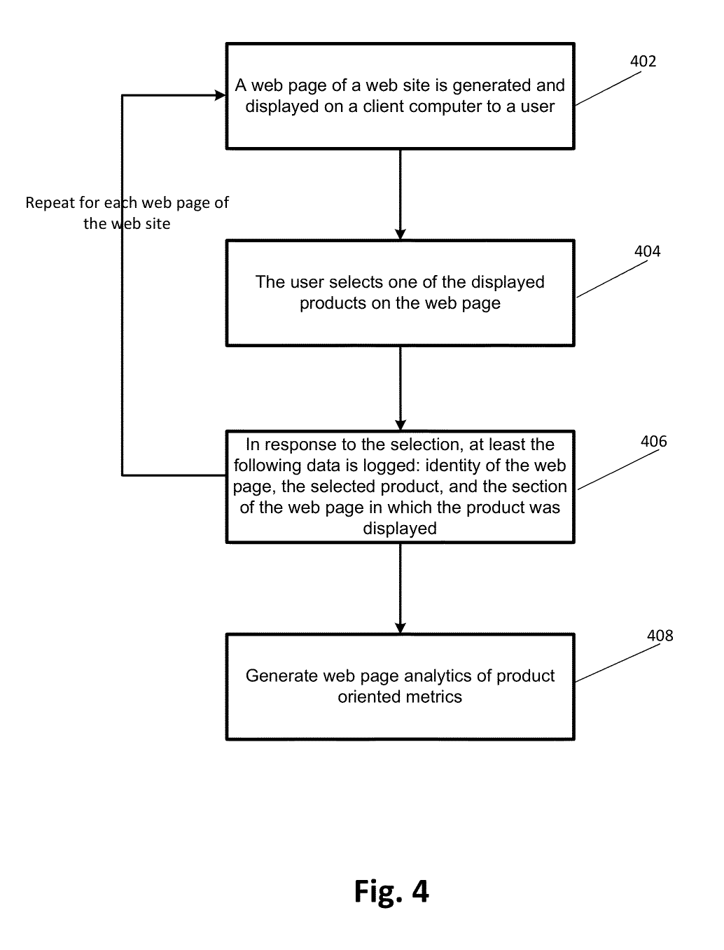

FIG. 4 is a flow diagram of the functionality of product oriented web site analytics module 16 of FIG. 1 when generating web site analytics based on the products displayed on a web site in accordance with one embodiment. In one embodiment, the functionality of the flow diagram of FIG. 4 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 402, a web page of a web site is generated and displayed on a client computer to a user. The web page includes a plurality of products, and each product is located at one of a plurality of sections of the web page.

At 404, a user selects one of the displayed products on the web page. The selection can include, for example, clicking on a link that corresponds to a URL. The data associated with the selection is received by module 16.

At 406, in response to the selection, at least the following data is logged: identity of the web page, the selected product, and the section of the web page in which the product was displayed.

At 408, after 402, 404, and 406 are repeated, web page analytics of product oriented metrics are generated. These metrics include an exposure score for a product that is based on the number of impressions of a product weighted by the sections of the web page that displayed the product.

As disclosed, embodiments generate product oriented web page analytics by logging data regarding both the product and the section of the web page in which the product was displayed. This and other logged data provides product specific metrics rather than mere page impression data.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to generate web page analytics, the instructions comprising:
generating a plurality of web pages, each web page comprising a plurality of products and a plurality of web page sections, wherein each product is displayed in at least one of the sections of the web page;
receiving a plurality of selections by a user of one or more of the products;
for each selection, logging data comprising a selected product and a section of the web page where the selected product was displayed when it was selected by the user; and
generating web page analytics from the logged data, wherein the analytics are based at least on the selected product and the corresponding section of the web page where the selected product was displayed.

2. The computer readable medium of claim 1, wherein the logged data further comprises application data comprising page content, page context and request metadata.

3. The computer readable medium of claim 1, wherein the logged data further comprises client data comprising page impressions, product clicks and user demographics.

4. The computer readable medium of claim 1, further comprising assigning a value to each of the sections of each web page.

5. The computer readable medium of claim 1, wherein the generating analytics comprises determining a total number of times a product has been displayed to the user.

6. The computer readable medium of claim 4, wherein the generating analytics comprises determining a total count of a number of times a product has been displayed to the user, wherein each count is weighted by the value corresponding to the displayed web page section.

7. The computer readable medium of claim 5, wherein the generating analytics comprises determining a total count of times the product is selected by the user.

8. The computer readable medium of claim 7, wherein the generating analytics comprises determining the total count of times the product is selected by the user divided by the total number of times the product has been displayed to the user.

9. The computer readable medium of claim 7, wherein the generating analytics comprises determining the total count of times the product is selected by the user multiplied by a price of the selected product.

10. The computer readable medium of claim 1, wherein the generating analytics comprises determining an opportunity score comprising a ratio of determining a total count of times the product is selected by the user divided by a total display count of a number of times a product has been displayed to the user, wherein each display count is weighted by the value corresponding to the displayed web page section.

11. A computer implemented method for generating web page analytics, the instructions comprising:
generating a plurality of web pages, each web page comprising a plurality of products and a plurality of web page sections, wherein each product is displayed in at least one of the sections of the web page;
receiving a plurality of selections by a user of one or more of the products;
for each selection, logging data comprising a selected product and a section of the web page where the selected product was displayed when it was selected by the user; and
generating web page analytics from the logged data, wherein the analytics are based at least on the selected product and the corresponding section of the web page where the selected product was displayed.

12. The method of claim 11, further comprising assigning a value to each of the sections of each web page.

13. The method of claim 11, wherein the generating analytics comprises determining a total number of times a product has been displayed to the user.

14. The method of claim 12, wherein the generating analytics comprises determining a total count of a number of times a product has been displayed to the user, wherein each count is weighted by the value corresponding to the displayed web page section.

15. The method of claim 13, wherein the generating analytics comprises determining a total count of times the product is selected by the user.

16. The method of claim 15, wherein the generating analytics comprises determining the total count of times the product is selected by the user divided by the total number of times the product has been displayed to the user.

17. The method of claim 15, wherein the generating analytics comprises determining the total count of times the product is selected by the user multiplied by a price of the selected product.

18. The method of claim 11, wherein the generating analytics comprises determining an opportunity score comprising a ratio of determining a total count of times the product is selected by the user divided a total display count of a number of times a product has been displayed to the user, wherein each display count is weighted by the value corresponding to the displayed web page section.

19. A web page analytics system comprising:
a processor coupled to a memory;
a web page generator module stored in the memory that is configured to generate a plurality of web pages of a web site, each web page comprising a plurality of products and a plurality of web page sections, wherein each product is displayed in at least one of the sections of the web page;
a receiving module stored in the memory that is configured to receive a plurality of selections by a user of one or more of the products;
for each selection, a logging module stored in the memory that is configured to log data comprising a selected product and a section of the web page where the selected product was displayed when it was selected by the user; and
a web page analytics module stored in the memory that is configured to generate web page analytics from the logged data, wherein the analytics are based at least on the selected product and the corresponding section of the web page where the selected product was displayed.

20. The system of claim 19, the web page analytics module further configured to assign a value to each of the sections of each web page.

21. The system of claim 19, wherein the generate web page analytics comprises determining a total number of times a product has been displayed to the user.

22. The system of claim 20, wherein the generate web page analytics comprises determining a total count of a number of times a product has been displayed to the user, wherein each count is weighted by the value corresponding to the displayed web page section.

23. The system of claim 21, wherein the generate web page analytics comprises determining a total count of times the product is selected by the user.

24. The system of claim 23, wherein the generate web page analytics comprises determining the total count of times the product is selected by the user divided by the total number of times the product has been displayed to the user.

25. The system of claim 23, wherein the generate web page analytics comprises determining the total count of times the product is selected by the user multiplied by a price of the selected product.

26. The system of claim 19, wherein the generate web page analytics comprises determining an opportunity score comprising a ratio of determining a total count of times the product is selected by the user divided by a total display count of a number of times a product has been displayed to the user, wherein each display count is weighted by the value corresponding to the displayed web page section.
